(19) United States
(12) Patent Application Publication
(10) Pub. No.: US 2025/0276845 A1
(43) Pub. Date: Sep. 4, 2025

(54) SYSTEM AND METHOD FOR BAG CONTROL IN A RECEPTACLE

(71) Applicant: Kenton Brett, Indianapolis, IN (US)

(72) Inventor: Kenton Brett, Indianapolis, IN (US)

(21) Appl. No.: 19/069,932

(22) Filed: Mar. 4, 2025

Related U.S. Application Data
(60) Provisional application No. 63/560,997, filed on Mar. 4, 2024.
(60) Provisional application No. 63/572,018, filed on Mar. 29, 2024.

(51) Int. Cl. B65F 1/06

(52) U.S. Cl. CPC B65F 1/065; B65F 2210/137

(57) ABSTRACT

A receptacle is configured to receive a bag, such as a trash bag. The receptacle includes an outer shell, a plunger, and a fan. The plunger is moveable relative to the outer shell. The fan is configured to be rotated when the plunger is moved relative to the outer shell. Rotation of the fan expels air from the receptacle and sucks the bag open within the receptacle.

### FIELD

This application relates to the field of garbage disposal and particularly to trash receptacles.

### BACKGROUND

One of the more popular trash cans is the kitchen stainless steel can, with a black plastic “inner bucket”. Users remove the bucket from the outer can, then remove the full bag of trash. The inner bucket makes cleaning easier, contains the bag while it is carried outside, and is designed to help trash bags tuck in, for better fit around the upper lip.

However, when the trash is heavy or compacted, it can push against the bucket walls, which can cause both friction and suction, as the bag is being pulled out. Users may need one hand to hold down the bucket, while using the other hand to pull the bag up and out. This can be inconvenient, awkward and strenuous. It can also cause holes, rips or complete failure of the bag.

When placing a new bag in the inner bucket, the bag often does not fully open, and a virtual airlock tends to keep the bag inwardly billowed, even as trash is placed inside. Lightweight trash often stays on top, leaving little or no room for more.

Over many years, various mechanisms have been invented to address some of these issues, but none have had notable success, for a variety of reasons.

### SUMMARY

A receptacle with fan is disclosed herein. The receptacle configured to receive a bag, such as a trash bag. The receptacle includes an outer shell, a plunger, and the fan. The plunger is moveable relative to the outer shell. The fan is configured to be rotated when the plunger is moved relative to the outer shell. Rotation of the fan expels air from the receptacle and sucks the bag open within the receptacle.

The above-described features and advantages, as well as others, will become more readily apparent to those of ordinary skill in the art by reference to the following detailed description and accompanying drawings. While it would be desirable to provide a system and method for bag control in a receptacle that provides one or more of these or other advantageous features as may be apparent to those reviewing this disclosure, the teachings disclosed herein extend to those embodiments which fall within the scope of the appended claims, regardless of whether they include or accomplish one or more of the advantages or features mentioned herein.

### BRIEF DESCRIPTION OF THE DRAWINGS

FIG. 1 is a rear view of a receptacle including an outer shell with fan and a bag support in the form of an inner bucket, the bag support configured for placement within the outer shell;

FIG. 2A is a lower perspective view of a rack-and-pinion arrangement with rack catch for the receptacle of FIG. 1;

FIG. 2B is a side view of the rack-and-pinion arrangement of FIG. 2A;

FIG. 3A is a plan view of a gear arrangement within a gearbox of the receptacle of FIG. 1;

FIG. 3B is a side perspective view of the gear arrangement of FIG. 3A, the gear arrangement connected to a fan;

FIG. 3C is a side view of the gearbox of FIG. 3A in isolation from the gears; FIG. 4 is a side view of the fan of FIG. 1;

FIG. 5A is a front view of an alternative embodiment of the inner bucket of FIG. 1:

FIG. 5B is a front view of another alternative embodiment of the inner bucket of FIG. 1;

FIG. 6 is a side perspective view of an alternative embodiment of the gearbox of FIG. 3A wherein a drive belt connects the gearbox to the fan;

FIG. 7A is a side perspective view of an alternative embodiment of the bag support of FIG. 1 wherein the bag support is provided by an inner platform;

FIG. 7B is a bottom perspective view of the platform of FIG. 7A;

FIG. 7C is a rear perspective view of the platform of FIG. 7A connected to a plunger, gearbox and fan;

FIG. 8 shows the plunger of FIG. 7C arranged on an exterior of a receptacle; and

FIG. 9 shows an alternative embodiment of the platform of FIG. 7A.

### DESCRIPTION

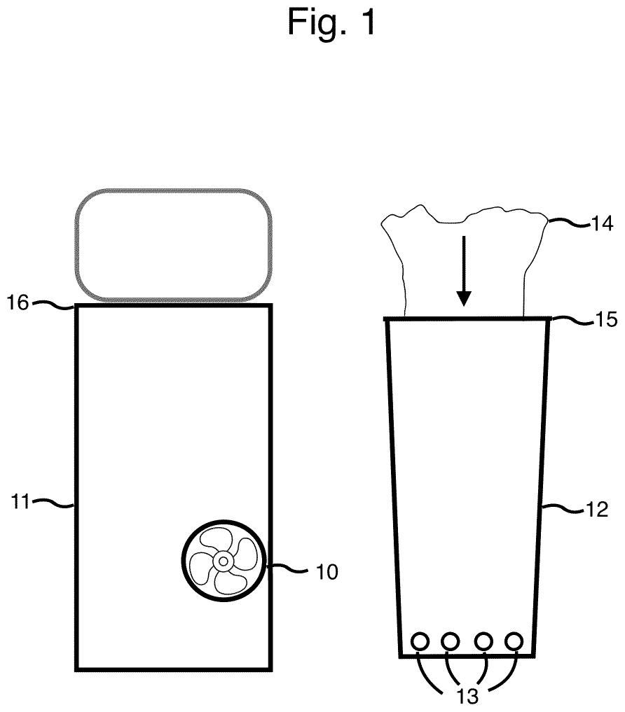

The present disclosure solves these issues of friction, suction, airlock and bag under-inflation in novel ways, as described herein. FIG. 1 illustrates a fan 10, mounted in the back wall of a receptacle having an outer shell 11 (which is also referred to herein as an “outer can”), and a bag support (e.g., an inner bucket 12) configured to receive or otherwise engage a bag and be positioned within the outer can 11. The fan 10 draws air outwardly or otherwise expels air from the outer can 11. When the inner bucket 12, with an already inserted trash bag 14 is put into place within the outer can 11, the upper rim 15 of the inner bucket 12 forms an approximate seal with the upper rim 16 of the outer can 11. So when the fan 10 is running, a vacuum forms in the space between the inner bucket 12 and the outer can 11. But since there are holes 13 in or near the bottom of the inner bucket 12, the trash bag 14 is pulled down and opened by the vacuum. In at least one embodiment, the fan 10 is located in the back of the outer can 11, but it may be positioned elsewhere, for example at the bottom of the outer can 11, under the inner bucket 12.

The fan can be powered by batteries or electricity from an outlet, and be switched on and off manually, or by limit switches, photo-sensors, timers or other means. But these require things many consumers do not want, like batteries, motors and power cords. Embodiments of the present disclosure aim to be simpler, more efficient, more ecological, less costly, and more durable, by using human power, via a mechanism requiring very little effort, and almost no extra time.

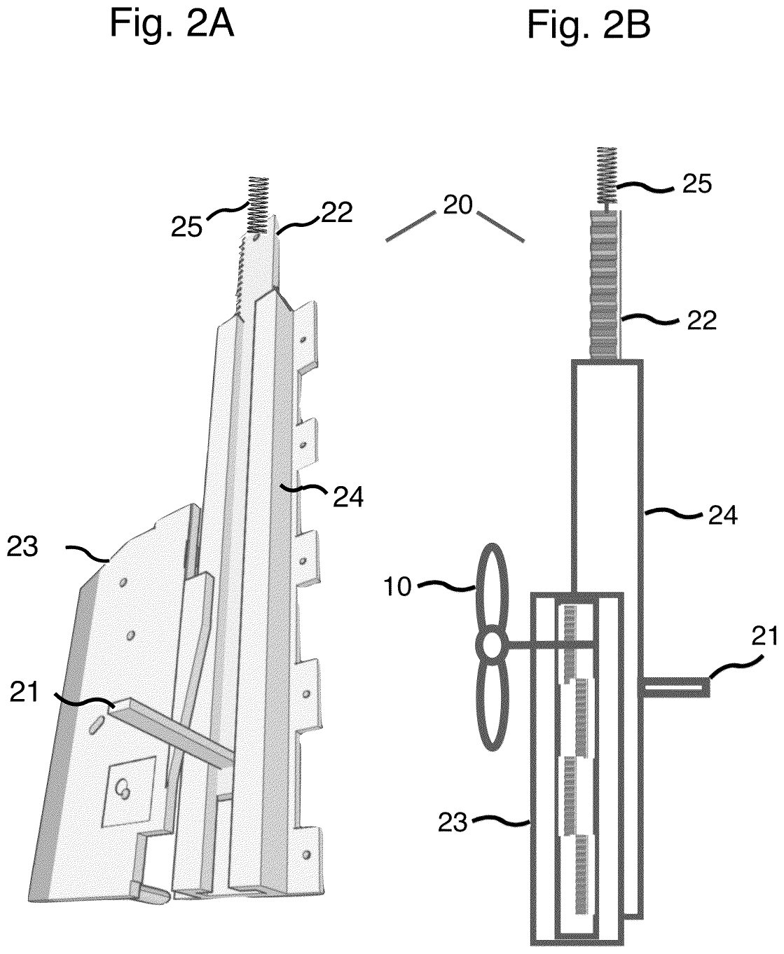

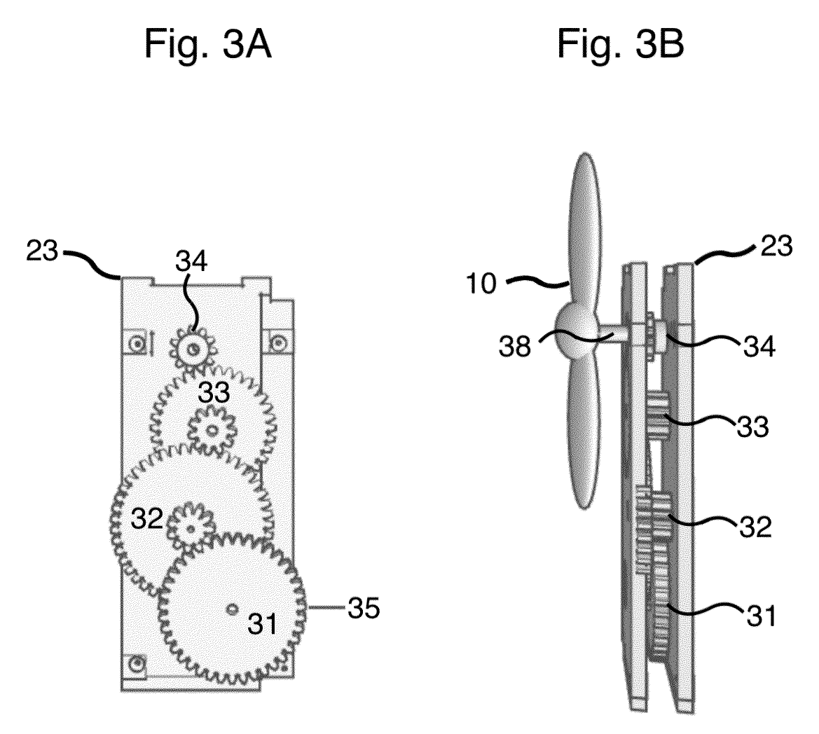

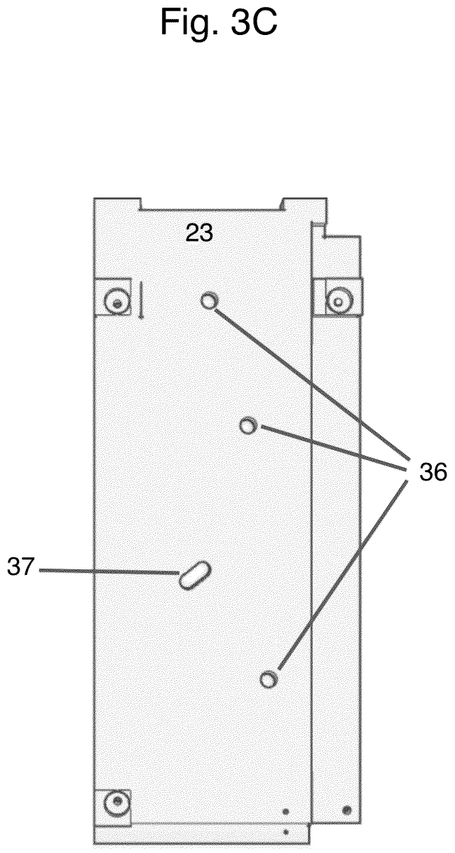

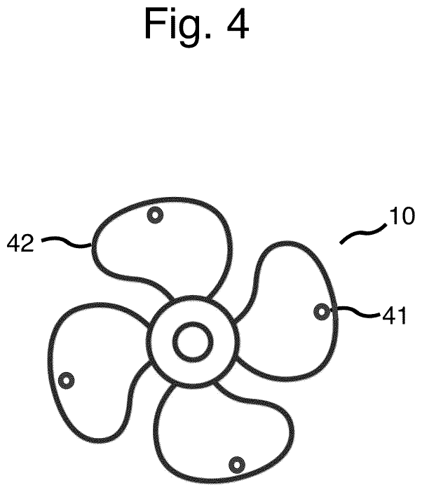

FIGS. 2A and 2B illustrate two views of the fan drive mechanism 20 of the present disclosure. FIG. 2A is a front view, and FIG. 2B is a side view. When users have placed a new trash bag 14 into the inner bucket 12, and then insert the inner bucket 12 into the outer can 11, the inner bucket 12 first lands on the rack catch 21, and begins pushing it down. This lowers the rack catch 21, and also its rigidly attached rack 22, which mechanically engages a gear arrangement within a gearbox 23. As rack 22 slides lower within rack channel 24, it continues to drive the first gear 31 (i.e., the pinion gear of a rack-and-pinion arrangement), and thus also gears 32, 33, and 34, as shown in FIGS. 3A and 3B. Rack 22 engages the first gear 31 at point 35. The final gear in gearbox 23 is fourth gear 34, which is attached to the fan 10 by the drive shaft 38. As the rack 22 lowers, it drives power through the gearbox 23 to propel the fan 10 to expel air from the outer can 11. The weight of the inner bucket 12 may not be adequate to drive the fan 10 at a sufficient speed to expel enough air, so the user may push down on the inner bucket 12, to achieve the desired fan speed.

The user need only push the inner bucket 12 down a few inches, to drive the fan 10 at high speed, due to the gear ratios in the gearbox 23. Since the user is already manually inserting the inner bucket 12, this short push requires almost no extra time, and little effort. In most prototype embodiments, the user presses down the inner bucket for approximately 1 second. During that time, the fan 10 is quickly expelling air. However, there is air leakage into the outer can 11, since the upper rim 15 of the inner bucket 12 is not yet seated against the upper rim 16 of the outer can 11. Therefore, the fan 10 is unable to fully inflate the bag.

But once the inner bucket 12 has been fully inserted, very little air can enter the outer can 11 from around the upper rim 15 of the inner bucket 12. As the fan 10 continues to run on momentum, it expels air rapidly, pulling the vacuum sufficient to suck open the trash bag 14 (i.e., inflate the bag) inside the inner bucket 12. Air holes 13, in or near the bottom of the inner bucket 12, allow the air surrounding the trash bag 14 to be pulled out, through the outer can 11, and expelled, thereby pulling the bag 14 down and open against the walls of the inner bucket 12. Next, the fan continues to run until its momentum dies from friction and air resistance.

For the fan 10 to continue running on momentum, it disengages from the rack 22, which stops moving upon full insertion of the inner bucket 12. This disengagement occurs within the gearbox 23, as shown in FIGS. 3A and 3C. FIG. 3C illustrates the gearbox 23 without the gears. Three holes 36 retain the shafts of first gear 31, third gear 33, and fourth gear 34 in a fixed location. The shaft of the second gear 32 slides within slot 37, allowing second gear 32 to engage or disengage the third gear 33. When the rack 22 is pushed down, it drives the first gear 31 to rotate clockwise, which drives the sliding gear 32 up, along the slot 37 to engage the third gear 33. The third gear 33 drives the fourth gear 34, which drives the fan 10 via the drive shaft 38. As the fan 10 continues on momentum, so does the fourth gear 34 and the third gear 33. This continued rotation of third gear 33, pushes the second gear 32 to move back down the slot 37 until the third gear 33 disengages the second gear 32. The mostly vertical arrangement of gears aids this disengagement, as gravity helps prevent unwanted movement of second gear 32 back up toward third gear 33.

To ensure the fan 10 momentum is sufficient to expel enough air, the fan 10 may be weighted and the gearbox 23 is designed for a reasonable downward force applied to the inner bucket 12, by the user as described above. In one embodiment, the fan 10, shown again in FIG. 4, has weights 41 attached near the outer edge of each fan blade 42, to increase angular momentum. This may also be accomplished with a flywheel attached to the hub of the fan blade assembly, or a larger diameter weighted ring attached across the outer edges of each fan blade, or by other means.

When the user removes the inner bucket 12, the rack catch 21 is no longer weighed down by the inner bucket 12, and the rack extension spring 25 can then pull the rack 22 up and along the rack channel 24, to its reset position. Since the second gear 32 is still disengaged from the third gear 33, raising the rack 22 does not drive the fan. Instead, it drives the first gear 31 counterclockwise, which, along with gravity, keeps the second gear 32 pushed away from the 3rd gear 33. In at least one embodiment, the gears and rack are not heavy, and are designed to move with little friction, so the rack extension spring 25 can be light duty, thus adding very little resistance to a user inserting the inner bucket 12.

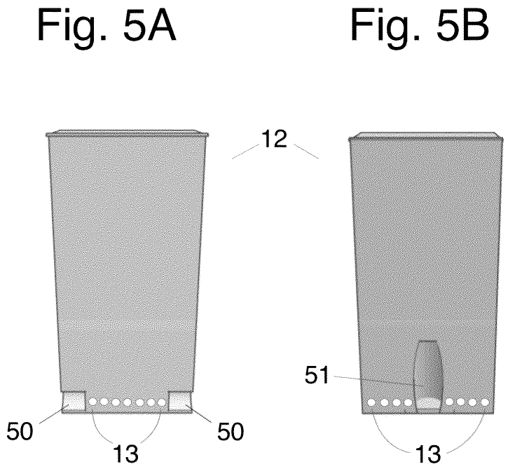

FIGS. 5A and 5B illustrate additional inner bucket 12 features of the present disclosure. At the bottom of the inner bucket 12, on each side is a concave foothold 50, of FIG. 5A, where users may step to hold down the inner bucket 12, while pulling the full trash bag 14 up and out of the inner bucket 12. This stabilizes the inner bucket 12, and firmly holds it to the floor, while allowing the user to use both hands to remove the trash bag 14. Another embodiment has only one foothold 51, of FIG. 5B, positioned front and center at the base of the inner bucket 12, and also is taller for easier foot insertion. Another embodiment may have both of these options (foothold 51 and footholds 50) for users to choose from. Other embodiments have different foothold locations, and different foothold sizes and shapes.

The air holes 13, in or near the bottom of the inner bucket 12, allow air to freely enter, immediately relieving any suction that may start to develop as the trash bag 14 is removed. To help contain any trash leakage, at least one embodiment positions the air holes 13 not in the bottom of the inner bucket 12, but in the side, near the bottom. This location aids in both insertion and extraction of trash bag 14.

Many trash cans have lid hinges that protrude from the back of the can, which prevents the lower part of the can from sitting flush against a wall or cabinet. This gap can provide room for the fan 10 and the air it will expel. One embodiment of the current disclosure has the fan 10 positioned entirely within the body of the outer can 11, which may be associated with the inner bucket 12 being contoured around the fan 10 and gearbox 23. Another embodiment has the fan 10 mounted on the outside of the outer can 11. Still other embodiments have the fan 10 positioned in between—for example, mostly inside or mostly outside the outer can 11. For safety, the fan 10 is covered by an inflexible screen or grate. Bladeless fans may also be used to increase safety.

Another embodiment uses a space underneath the inner bucket 12 to mount the fan 10, which may be driven by a belt, worm gear, drive shaft or other means extending from the gearbox 23 to the fan 10. In this embodiment, the lower portion of the outer can 11 has vents, through which the fan 10 expels the air from the outer can 11.

The high fluidity of air allows for many fan placement options. For better dispersion of expelled air, some placement options may benefit from the use of centrifugal fans or diagonal fans instead of the axial fan shown in FIG. 4.

In transferring power to the fan 10, another embodiment uses pulleys and belts, such as V-belts or timing belts, or chains or cables instead of a rack and gears. Another embodiment uses one or more freely spinning cylinders with spiraled slots, wherein a key inserted into the slot is driven downward during insertion of the inner-bucket, thereby spinning the slotted cylinder, to provide power for the fan 10. The pitch of the spiraled slots may be varied, to impart more control to fan acceleration.

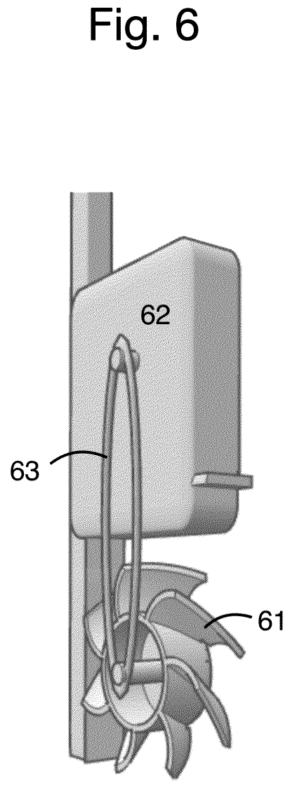

In the design shown in FIGS. 2B and 3B, the fan 10 is directly attached to the final gear 34 in the gearbox 23. This configuration adds thickness to the assembly which may cause the fan 10 to stick out of the trash can undesirably far. FIG. 6 illustrates one embodiment designed to reduce the total thickness, by stacking the fan 61 and gearbox, shown here as enclosed gearbox 62, using a timing belt 63 to transfer power from the enclosed gearbox 62 to the fan 61. Instead of a timing belt, a V-belt, chain, driveshaft, worm gear or other means may be used. The design in FIG. 6 also removes the enclosed gearbox 62 from the path of airflow, which can increase efficiency. A fully enclosed gearbox is quieter, keeps the gears cleaner, and helps contain gear lubricant. But if the open gearbox 23 of FIGS. 3A-3C were fully enclosed it might hinder airflow. This may be another advantage of the configuration of FIG. 6.

In other embodiments, the rack catch 21 shown in FIGS. 2A and 2B, can be replaced by a platform, or one or more cross-members, such as bars, cables, wires, or beams, which span fully or partially from one side to another, and may be fully or partially supported by, attached to, guided by or mounted on supports such as springs, cables, racks, screws rails or gears.

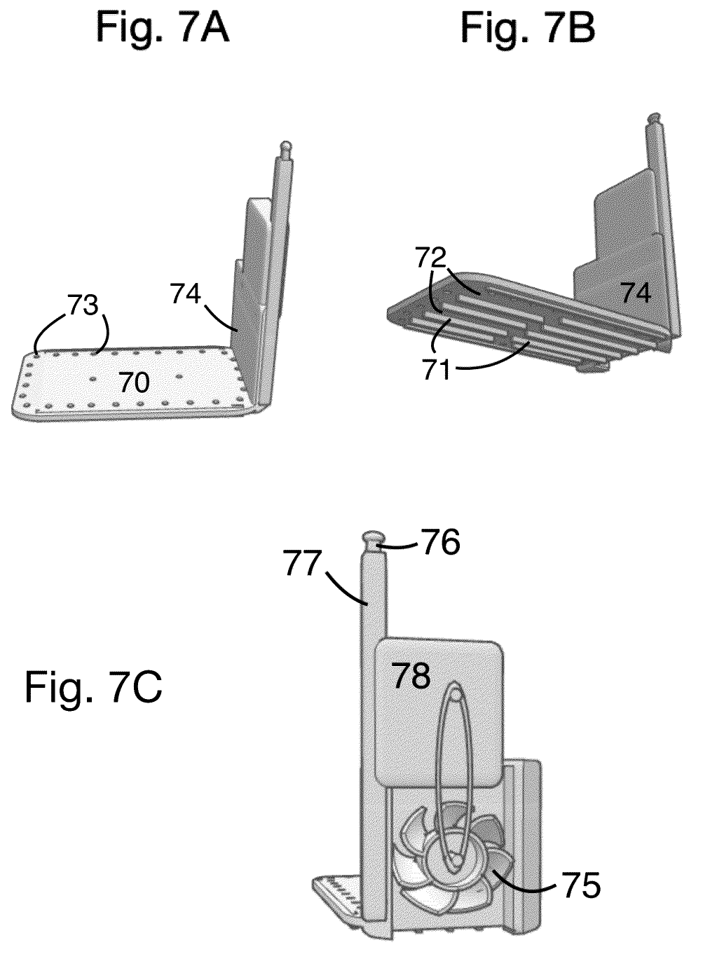

FIGS. 7A-7C show three views of another embodiment, which is designed for trash cans having no inner bucket. A platform 70 is made to fit into the bottom of the can, with the fit being tight enough to create a virtual air seal with the can. A gasket may be used to enhance the seal. Ribs 71 on the underside of the platform 70 hold the platform 70 up off the bottom of the trash can (e.g., between one inch and three inches above the bottom of the trash can), thus creating a cavity between the platform 70 and the bottom of the trash can. The ribs 71 are substantial to support the weight of heavy trash or items that may be placed on the platform 70. The ribs 71 are formed and arranged to leave channels 72 through the cavity under the platform 70, which allow air to flow freely throughout the cavity. Holes 73 in the platform 70 allow air to flow from the trash can into the cavity under the platform 70. Arising from one side of the platform 70, is an air duct 74, leading to the exhaust fan 75.

There may be numerous acceptable designs for the ribs 71 and channels 72. For example, some designs might channel all air from the holes toward a large central channel which leads to the air duct 74. But air is extremely fluid, so as long as it can freely flow from any hole to the air duct 74, the precise airflow pathways may be of little consequence. Of more consequence is the hole pattern, designed to pull the bag down and toward the outer walls of the can. Ribs positioned vertically up the walls of the can seem to aid in fully opening the bag, but only marginally. Various hole patterns work well, even without the vertical ribs, and there may be many hole patterns that work well. The pattern shown in FIG. 7A has most holes lining the outer rim, to pull the bag down and outward.

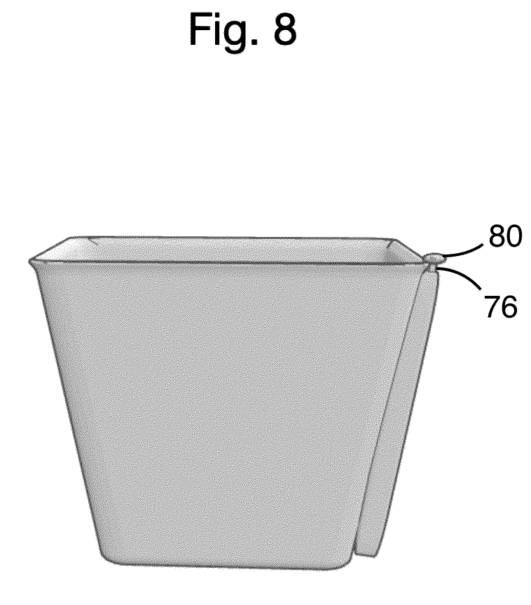

The embodiment shown in FIGS. 7A-8 use the same mechanical system (rack, gearbox, and fan) as that of FIGS. 2A-3B and FIG. 6. But when there is no inner bucket for users to push down, the system is powered in some other way. In this embodiment, a hand plunger 76 is attached to the rack (inside housing 77), or may be manufactured as rack and plunger being one piece. Just as the rack of FIGS. 2A and 2B is mechanically attached to gearbox 23 of 3A and 3B, the plunger 76 drives power through the gearbox 78 and to the fan 75. When the plunger 76 is completely down in its resting position, it appears to the user as a small knob 80 on the end of the plunger, as shown in FIG. 8. The user pulls up the knob 80, thereby pulling up the plunger 76. This is easy, since the 2nd gear 32 is disengaged from 3rd gear 33 (referring to the gearbox 23 of FIGS. 2A-3B). The user then pushes the plunger 76 down, to drive the fan, which pulls air from the space between the bag and the can, the air then traveling down through holes 73 into the cavity below the platform 70, and through the channels 72 between the ribs 71, then through the duct 74 to the fan 75, which expels the air. This embodiment could also be used with cans having inner buckets, but perhaps with less added benefit.

The assembly that includes the air duct 74, gearbox 78, rack housing 77 and plunger 76 may be built into an outer wall of the trash can, or be contained completely within it, or be mounted onto the outside of it, or something in between.

There are several ways to minimize interference of the knob 80 and plunger 76 with the upper rim of the trash bag. For example, the knob 80 and plunger 76 can be positioned just outside the lip of the trash can. Or the lip of the trash can, can be made concave at that point, to circumvent the knob 80 and plunger 76. In another embodiment, the plunger 76 slides in a slot or C-channel mounted on the outside of the trash can, with the C-channel extending only to just below the lip of the trash can. This allows the knob 80 to protrude horizontally from the rack, further distancing it from the trash bag. Also, the plunger can be mounted closer to the bottom and can be operated either by hand or by foot. With some trash can designs, this may work better with a spring, which always returns the rack and plunger 76 to the up position, ready to plunge downward, without having to manually raise the plunger 76 each time. This may work better in conjunction with a dashpot for a “soft reset” of the plunger 76. This embodiment can be applied to trash cans with inner buckets too, wherein the inner bucket does not engage the mechanism. Instead, the user inserts the bucket completely, and then pulls down, or pushes down a plunger mounted within or onto the side of the trash can. This could be positioned for hand use or for foot use. The plunger can be located at the top, and be pulled up manually each time, or be mounted lower, and be automatically pulled up by a spring, along with a dashpot for a “soft reset”. Alternately, instead of an extension spring to pull up a rack or plunger from above, a compression spring can be used to push it up from below. This allows more placement options for the rack or plunger 76.

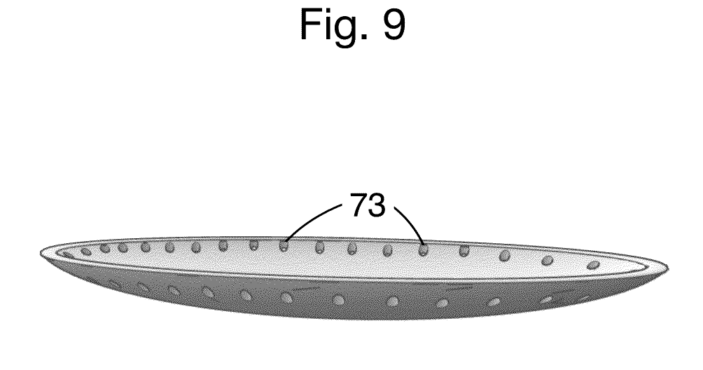

The platform 70 can be designed to permanently attach to the trash can or attached with easily removed fasteners to aid in cleaning. Or it can be designed to simply drop into place, or snap into place, for even easier cleaning. If there is any trash fluid leakage, the platform design shown in FIGS. 7A-7C can allow some of the leakage into the cavity under the platform. To help minimize this issue, the platform can be designed with the air holes 73 positioned above the central base of the platform, as shown in FIG. 9. Each air hole 73 may also have a lip around its perimeter to help channel any leakage away from the hole.

In some bucket-less cans the plunger can be made shorter than the rack of an equivalent can that does have an inner bucket. This is because while the bucket is being pushed down to power up the fan, mass air is leaking around the bucket into the can. But with bucket-less cans, there is no such initial period of mass air leakage. Instead, the bag begins to pull open when the user starts pushing down the plunger. If some trash can designs need additional rack length to attain the power needed, a flexible rack can be used, wherein the flexible rack follows inside a curved sleeve or c-channel to curl under or along the base of the can.

Some products have features that users can opt to disengage or turn off. With the embodiments described herein, this could be done in any of several ways. For example, the top of the rack ex-tension spring can be attached to a releasable fixture, such that users can switch it to unlock, whereupon the releasable fixture will slide down a channel to the spring's fully relaxed position. To reset it, the users slides the fixture back to its original position, and switches it to lock. A locking lever can be used instead, which would perform both tasks-resetting and locking the fixture. With the plunger embodiment, a switch brake can be mounted on the plunger to lock it in place.

Many of the embodiments herein disclosed can be retrofitted to existing trash cans, including those with inner buckets, and those without. However, integrating these embodiments into new trash can designs may result in better products and better user experiences.

The present disclosure can be used with many different sizes and designs of cans, bins and containers of all types, including but not limited to: trash cans, recycle cans, storage containers, bio-hazard cans, supply bins, such as industrial bins containing parts and materials for assembly.

The foregoing detailed description of one or more embodiments of the trash can with fan has been presented herein by way of example only and not limitation. It will be recognized that there are advantages to certain individual features and functions described herein that may be obtained without incorporating other features and functions described herein. Moreover, it will be recognized that various alternatives, modifications, variations, or improvements of the above-disclosed embodiments and other features and functions, or alternatives thereof, may be desirably combined into many other different embodiments, systems or applications. Presently unforeseen or unanticipated alternatives, modifications, variations, or improvements therein may be subsequently made by those skilled in the art which are also intended to be encompassed by any appended claims. Therefore, the spirit and scope of any eventually appended claims should not be limited to the description of the embodiments contained herein.

What is claimed is:

1. A receptacle configured to receive a bag, the receptacle comprising:
an outer shell;
a plunger moveable relative to the outer shell; and
a fan configured to be operated when the plunger is moved relative to the outer shell.

2. The receptacle of claim 1, wherein rotation of the fan expels air outwardly from the receptacle.

3. The receptacle of claim 2, further comprising a bag support moveably positioned within the outer shell.

4. The receptacle of claim 3, further comprising a gear arrangement, the plunger configured to engage the bag support and the gear arrangement.

5. The receptacle of claim 4, wherein movement of the plunger in a downward direction causes the gear arrangement to rotate the fan and expel air outwardly from the receptacle.

6. The receptacle of claim 5, wherein the plunger is a rack of a rack-and-pinion arrangement and the gear arrangement includes a pinion of the rack-and-pinion arrangement.

7. The receptacle of claim 6, wherein the bag support is an inner bucket including at a plurality of holes at a bottom portion of the bucket.

8. The receptacle of claim 7, wherein the rack is connected to a rack catch positioned within the outer shell and configured to engage the inner bucket.

9. The receptacle of claim 1, further comprising a bag support provided by a platform above a bottom of the receptacle with a plurality of holes formed in the platform, wherein the fan is configured to direct air through the holes in the platform when the plunger is moved relative to the outer shell.

10. The receptacle of claim 9 further comprising ribs on an underside of the platform, wherein the ribs distance the platform above the bottom of the receptacle such that a cavity is formed between the platform and the bottom of the receptacle, the fan configured to direct air through the holes in the platform and into the cavity when the plunger is moved relative to the outer shell.

11. A system for installing a bag in a receptacle, the receptacle comprising:
an outer shell configured to receive the bag therein;
a mechanical actuator that is moveable relative to the outer shell; and
a fan configured to be rotated when the actuator is moved relative to the outer shell.

12. The system of claim 11 wherein the mechanical actuator is a plunger.

13. The system of claim 12 further comprising a bag support removably positioned within the outer shell, the bag support configured to receive the bag.

14. The system of claim 13 wherein the bag support moves the plunger when the bag support is inserted into the outer shell.

15. The system of claim 12 wherein the plunger includes an end configured to be grasped by a human hand on an exterior of the outer shell.

16. The system of claim 12 further comprising a gear arrangement coupling the plunger to the fan, the gear arrangement including a pinion and the plunger serving as a rack of a rack-and-pinion system.

17. The system of claim 12 further comprising a platform positioned within the outer shell, the platform positioned above a bottom of the outer shell such that a cavity is formed between the platform and the bottom of the outer shell.

18. The system of claim 17 further comprising ribs connected to the platform and distancing the platform from the bottom of the outer shell.

19. The system of claim 18 wherein the platform includes a plurality of holes such that rotation of the fan is configured to direct air through the plurality of holes.

20. A method of controlling a bag in a receptacle comprising:
positioning the bag in the receptacle; and
moving an actuator in order to operate a fan and draw air through the receptacle such that the bag is inflated within the receptacle.
